(19) United States
(12) Patent Application Publication
(10) Pub. No.: US 2018/0133835 A1
(43) Pub. Date: May 17, 2018

(54) Switchable Compound Laser Machine

(71) Applicant: Great Computer Corp., New Taipei City (TW)

(72) Inventors: Yu-Sheng WU, New Taipei City (TW); Che-Min KUNG, New Taipei City (TW); Liang SHIH, New Taipei City (TW)

(21) Appl. No.: 15/353,222

(22) Filed: Nov. 16, 2016

(51) Int. Cl. B23K 26/00; B23K 26/70

(52) U.S. Cl. CPC B23K 26/0066; B23K 26/707

(57) ABSTRACT

A switchable compound laser machine is disclosed, wherein the laser tubes of output module have different laser wavelengths; the automatic focusing module includes a mechanical electronic switch for providing a zero point positioning signal of the selected laser focal distance; the control module connects to the output modules, the at least one switchover module, the automatic focusing module and the work platform respectively for controlling the output of the laser tube of the selected output module, and controlling mirror of the switchover module corresponding to the selected output module to displace on the laser output path of the laser tube of the selected output module for changing the laser output direction, and displace the work platform based on the selected laser tube wavelength and the selected zero point positioning signal of laser focal distance for adjusting the focal distance position of the selected output laser.

### BACKGROUND OF THE INVENTION

### Field of Invention

The present invention relates to a switchable compound laser machine and more particularly to a switchable compound laser machine having a plurality of output modules with different wavelengths for cutting or engraving at different depths of workpieces.

### Related Art

The basic working principle of common laser processing machines is to guide and focus laser beams on surfaces of objects which need to be engraved. The materials of the objects are gasified due to sudden increase of temperature when the focused laser beams are absorbed by the materials, and therefore the surfaces of the objects are indented. Thus the objective of engraving or cutting is achieved.

The process of engraving and cutting by laser is very simple, just like unto printing on paper by using a computer and a printer. The only difference is, for printing, toner is printed on paper; as for laser engraving, focused laser is projected on nearly all kinds of materials such as wood, acrylic, plastic, metal, stone, etc.

However, existing laser engraving and cutting machines are mainly divided into the metal and non-metal processing. Therefore, lasers with different wavelengths are required for processing. For examples, fiber optic laser machine is suitable for metal cutting and engraving, while carbon dioxide (CO2) laser machine is suitable for non-metal cutting and engraving. Therefore, when a workpiece has both metal and non-metal materials; the fiber optic laser machine is used for metal engraving, and the carbon dioxide laser machine is used for non-metal cutting and engraving. However, users have to change between the two types of machines, and thus are inconvenient in usage. Furthermore, the extra space required for storing the machines and the increased costs are the disadvantages. Therefore, some manufacturers have developed machines with laser tubes having two different wavelengths. Laser coupling lens is used for the laser conjoined point of the two laser tubes of such machines. Because laser tubes with different wavelengths have different laser focal distances, wavelengths of the laser tubes of such machines have to be the same or very close to each other. As a result, the variability of engraving and cutting is limited.

Furthermore, the carbon dioxide laser engraving and cutting machine is mainly divided into metal tube laser and glass tube laser. Wattage unit price of the metal tube laser machine is high and is suitable for engraving; while wattage unit price of the glass tube laser machine is low and is suitable for cutting. Therefore, the metal tube laser machine is used for engraving; while the glass tube laser machine is used for cutting. However, users have to change between the two types of machines, and thus are inconvenient in usage. Furthermore, the extra space required for installing the machines and the increased costs are the disadvantages. Therefore, some manufacturers have developed machines with two laser tubes. Laser coupling lens is used for the laser conjoined point of the two laser tubes of such machines. Because the glass tube laser is randomly polarized, the laser coupling effect is tremendously limited, and also causes large power drop. As a result, it will be very difficult in designing the laser coupling lens.

### SUMMARY OF THE INVENTION

In view of the above drawbacks, a switchable compound laser machine of the present invention is provided for enhancing the variability of engraving and cutting as well as the product competitiveness.

A primary object of the present invention is to provide a switchable compound laser machine with more than two sets of laser output modules. A work platform of the switchable compound laser machine being displaceable upward and downward based on the selected laser tube wavelength and laser focal distance, enabling a workpiece on the work platform to move under the laser focal distance for processing with different laser sources.

In order to achieve the above-mentioned objectives, the present invention of a switchable compound laser machine comprises a machine, as well as a plurality of output modules, at least one switchover module, an automatic focusing module, a control module and a work platform disposed on the machine. Each of the output modules comprises a laser tube for laser output, and each of the laser tubes has a predetermined laser wavelength. The at least one switchover module has at least one mirror, and the mirror is moved for changing the laser output direction. The automatic focusing module comprises a mechanical electronic switch with selective laser focal distances for providing a zero point positioning signal of the selected laser focal distance. The control module is respectively connected to the output modules, the at least one switchover module, the automatic focusing module and the work platform for controlling the output of the laser tube of the selected output module based on the selected zero point positioning signal of laser focal distance of the automatic focusing module, and controlling a mirror of the at least one switchover module to displace on the laser output path of the laser tube of the selected output module in order to change the laser output direction, and displace the work platform based on the selected laser tube wavelength and the selected zero point positioning signal of laser focal distance for adjusting the focal distance position of the output laser.

When the switchable compound laser machine is embodied, the output modules output engraving operation or cutting operation selectively.

When the switchable compound laser machine is embodied, the laser tubes of the output modules have the same or different wavelengths.

When the switchable compound laser machine is embodied, the automatic focusing module initializes the laser focal distance from a surface of the workpiece.

When the switchable compound laser machine is embodied, the switchable compound laser machine further comprises a microprocessor module disposed on the machine and connected to the control module. The microprocessor module is used for receiving at least one work command and then driving the control module to control the output modules and the at least one switchover module to output, and controlling the displacement of the work platform based on the zero point positioning signal of laser focal distance.

The present invention will become more fully understood by reference to the following detailed description thereof when read in conjunction with the attached drawings.

### BRIEF DESCRIPTION OF THE DRAWINGS

FIG. 1 is a framework diagram of a switchable compound laser machine according to an embodiment of the present invention;

FIG. 2 is a perspective view according to the embodiment of the present invention in FIG. 1;

FIG. 3 is a schematic view of activating an output module for engraving according to the embodiment of the present invention in FIG. 1; and

FIG. 4 is a schematic view of activating the output module for cutting according to the embodiment of the present invention in FIG. 1.

### DETAILED DESCRIPTION OF THE INVENTION

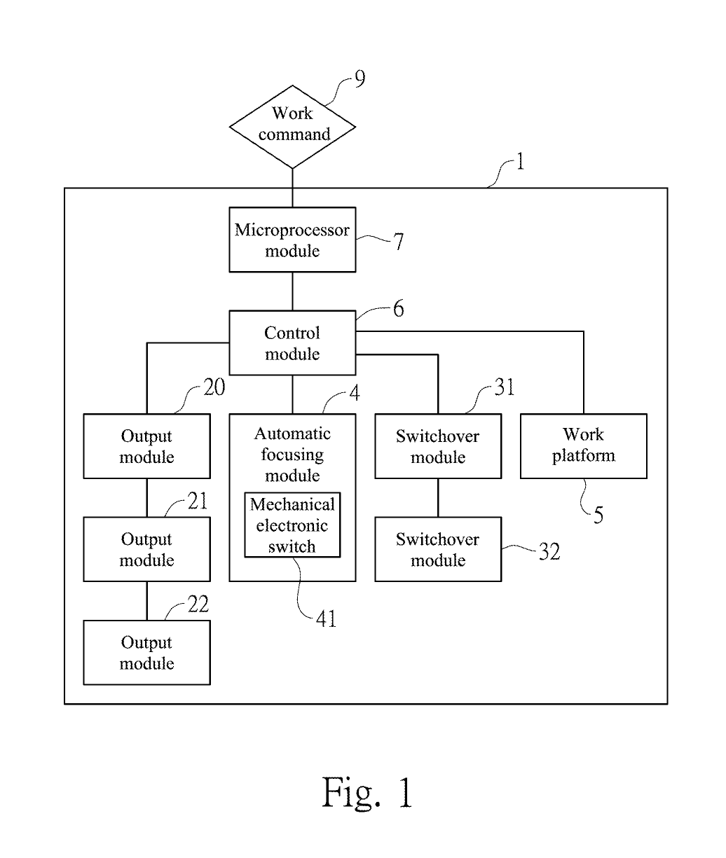

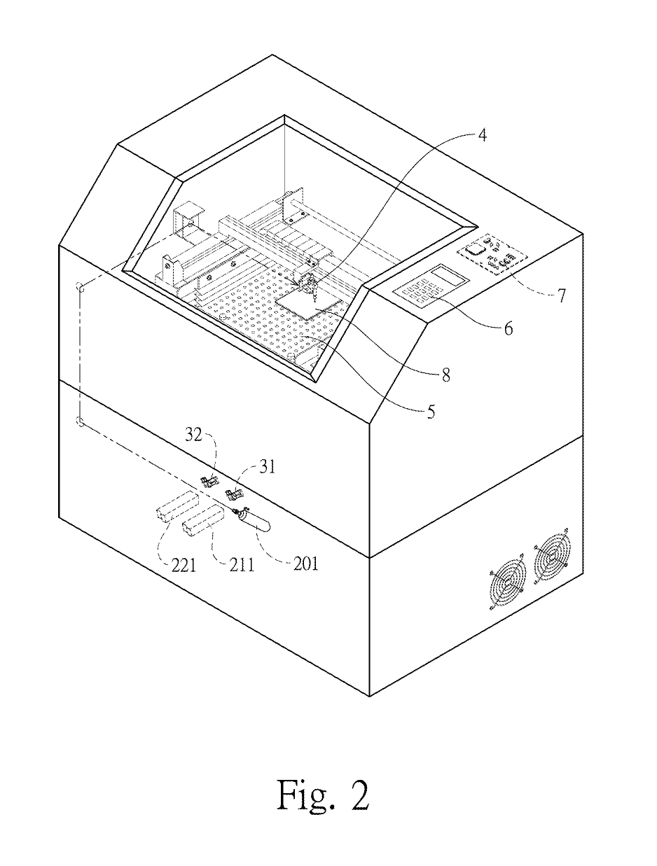

Please refer to FIGS. 1 to 3 for an embodiment of a switchable compound laser machine of the present invention. The switchable compound laser machine is composed of a machine 1, as well as three output modules 20, 21 and 22, two switchover modules 31 and 32, an automatic focusing module 4, a work platform 5, a control module 6 and a microprocessor module 7 disposed on the machine 1.

The output modules 21, 22 are engraving modules disposed with laser tubes 211, 221 for engraving. The laser tube 211 is a carbon dioxide metal tube laser, and the laser tube 221 is a fiber optic laser for outputting engraving processes. The output module 20 is a cutting module disposed with a laser tube 201 for cutting, and is a carbon dioxide glass tube laser for outputting cutting processes. The metal tube laser of the output module 21 and the glass tube laser of the output module 20 have the same laser wavelength and focal distance. The output module 22 has a laser wavelength and a focal distance different from those of the metal tube laser of the output module 21.

The switchover modules 31, 32 are disposed corresponding to the output modules 21, 22, and are disposed with mirrors 311, 321 respectively. By moving one of the mirrors 311, 321, the laser output directions of the output modules 21, 22 are changed respectively.

The automatic focusing module 4 comprises a mechanical electronic switch with selective laser focal distances for providing a zero point positioning signal of the selected laser focal distance. Additionally, the automatic focusing module 4 initializes the laser focal distance of each of the output modules 20, 21, 22 from a surface of a workpiece 8. Zero point positioning is performed for the surface of the workpiece 8 on the work platform 5 by the automatic focusing module 4. Based on the zero point positioning, the work platform 5 moves to the laser focal distance value set in the control module 6 for each of the output modules 20, 21 and 22.

The work platform 5 is provided for placing the workpiece 8 on top. The work platform 5 is controlled to displace upward and downward vertically.

The control module 6 is electrically connected to the output modules 20, 21, 22, the switchover modules 31, 32, the automatic focusing module 4 and the work platform 5 respectively for controlling the output of the laser tube of the selected output module and controlling the mirror of the switchover module corresponding to the selected output module to displace on the laser output path of the laser tube of the selected output module in order to change the laser output direction, and displace the work platform vertically based on the selected laser tube wavelength and the selected zero point positioning signal of laser focal distance for adjusting the focal distance position of the output laser of the selected output module.

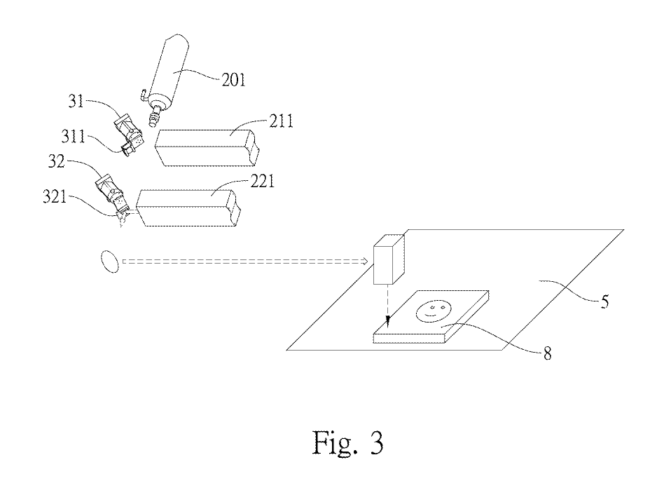

When the switchable compound laser machine is embodied, and the output module 22 is used for engraving as an example as shown in FIG. 3. Press an automatic focusing button (not shown in the figure) on a control panel disposed on the machine 1, or send an automatic focusing command by a work command 9 in order that the zero point positioning signal of laser focal distance of the output module 22 is sent by a mechanical electronic switch 41 of the automatic focusing module 4 to the control module 6. Then, the control module 6 sends an engraving command to the switchover module 32 in order to turn and move the mirror 321 onto the laser path of the output module 22. The control module 6 controls the work platform 5 to displace upward or downward based on the zero point positioning signal of laser focal distance sent by the automatic focusing module 4, and makes a to-be-processed area of a surface of the workpiece 8 on the work platform 5 to locate at the laser focal distance of the output module 22. Then, the control module 6 sends the engraving command to the output module 22 and makes the laser tube 221 to fire. The mirror 321 changes the path of the laser of the laser tube 221 to the predetermined laser processing path for engraving the workpiece 8.

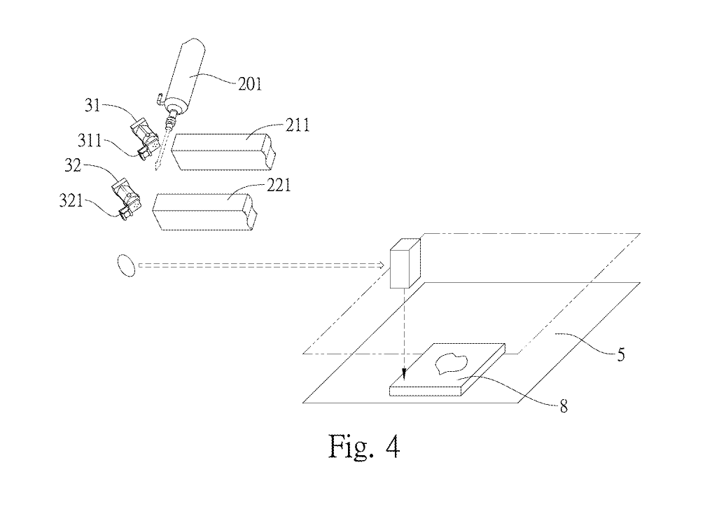

Please refer to FIG. 4 for switching to perform cutting. The control module 6 sends a command to the switchover modules 31, 32, and makes the mirrors 311, 321 to move away from the laser path of the output module 20 and restore to the original positions. Then, the control module 6 sends a cutting command to the output module 20 and makes the laser tube 201 to fire. The laser firing by the laser tube 201 is not blocked by the mirror 311, 321 and performs cutting along the predetermined laser processing path.

Therefore, when users want to perform engraving, the work command 9 for engraving and parameters are input into the microprocessor module 7. The microprocessor module 7 drives the control module 6 to control the operations of the laser tubes 201, 211, 221 of the output modules 20, 21, 22. Before the laser is fired, the corresponding mirror 311 or 312 of the switchover modules 31 or 32 is moved in order to change the laser output path. Furthermore, the differences of the laser focal distances of the output modules 20, 21, 22 are used for forming patterns or grains with different color shades on the workpiece 8. When changing the output modules with different laser wavelengths, press the automatic focusing button corresponding to the laser focal distance of the output module to be switched to, or input the automatic focusing command via the work command 9 for adjusting the laser output path and the position of the work platform 5 in order that the to-be-processed area of the workpiece 8 on the work platform 5 locates at the laser focal distance of the output module after switching.

Furthermore, when users want to perform cutting, the work command 9 for cutting and parameters are input into the microprocessor module 7. The microprocessor module 7 drives the control module 6 to control the operations of the glass tube laser of the output module 20. Thereby, both the engraving and cutting operations can be performed for the workpiece 8 on the same machine 1. As a result, the processing time required can be reduced and the processing efficiency can be enhanced.

According to the above disclosure, the switchable compound laser machine of the present invention can achieve the expected objectives of reducing the processing time and enhancing the processing efficiency, and thus the product competitiveness can also be enhanced.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A switchable compound laser machine, comprising:
a machine with a work platform being displaceable upward and downward vertically for placing a workpiece thereon;
a plurality of output modules disposed on the machine, wherein each of the output modules comprises a laser tube for outputting laser, and each of the laser tubes has a predetermined laser wavelength;
at least one switchover module disposed on the machine, the switchover module having at least one mirror for changing the laser output direction by moving the mirror;
an automatic focusing module disposed on the machine for providing a zero point positioning signal of a selected laser focal distance; and
a control module disposed on the machine, the control module being connected to the output modules, the at least one switchover module, the automatic focusing module and the work platform respectively for controlling the output of the laser tube of the selected output module based on the selected zero point positioning signal of laser focal distance of the automatic focusing module, and controlling the mirror of the at least one switchover module to displace on the laser output path of the laser tube of the selected output module in order to change the laser output direction, and displace the work platform based on the selected laser tube wavelength and the selected zero point positioning signal of laser focal distance for adjusting the focal distance position of the output laser.

2. The switchable compound laser machine as claimed in claim 1, wherein the output modules output engraving operation or cutting operation selectively.

3. The switchable compound laser machine as claimed in claim 2, wherein the laser tubes of the output modules have the same or different wavelengths.

4. The switchable compound laser machine as claimed in claim 1, wherein the automatic focusing module initializes the laser focal distance from a surface of the workpiece.

5. The switchable compound laser machine as claimed in claim 1, wherein the machine further comprises a microprocessor module disposed on the machine and connected to the control module, the microprocessor module being used for receiving at least one work command and then driving the control module to control the output modules and the at least one switchover module to output, and controlling the displacement of the work platform based on the zero point positioning signal of laser focal distance.
